(19) United States
(12) Patent Application Publication
(10) Pub. No.: US 2011/0308694 A1
(43) Pub. Date: Dec. 22, 2011

(54) Medium Density Fibreboard

(75) Inventors: Thomas Neel, Panora, IA (US); Davis W. Thompson, Kelowna (CA); Timothy McDermott, Jamaica, IA (US); William Priestly, Guthrie Center, IA (US); Barry Monagham, Guthrie Center, IA (US)

(73) Assignee: PROMOMCNE, LLC, Panora, IA (US)

(21) Appl. No.: 13/163,425

(22) Filed: Jun. 17, 2011

Related U.S. Application Data
(62) Division of application No. 11/466,318, filed on Aug. 22, 2006.
Application No. 11/466,318 is a continuation-in-part of application No. 11/213,180, filed on Aug. 26, 2005, now abandoned.
Application No. 11/213,180 is a continuation-in-part of application No. PCT/US06/29358, filed on Jul. 28, 2006.

(51) Int. Cl. B27N 3/04

(52) U.S. Cl. 156/62.4

(57) ABSTRACT

The process described herein presents a unique method and means of manufacturing medium density fibreboard (MDF) using agricultural plant stalks. The plant stalks are first depithed. The stalks are then broken down into fiber-like threads and made into fiber bundles. These fiber bundles are then combined with a resin component and a wax component, and the resulting mixture is cured. The MDF is economical to manufacture than prior art fibreboard in that it does not necessitate the use of expensive MDI resin. Further, the fibreboard is environmentally friendly in that it provides a beneficial use for agricultural waste.

### CROSS-REFERENCE TO RELATED APPLICATION

This is a divisional of U.S. patent application Ser. No. 11/466,318, filed Aug. 22, 2006, which is a continuation-in-part of U.S. patent application Ser. No. 11/213,180, filed Aug. 26, 2005. It also claims priority to PCT App. No. PCT/US06/029358 filed Jul. 28, 2006. The disclosures of these applications are hereby specifically incorporated by reference.

### FIELD OF THE INVENTION

This invention relates to the use of agricultural waste product, namely agricultural stalks, in the manufacture of medium density fibreboard.

### BACKGROUND OF THE INVENTION

Economic growth and development worldwide have generated unprecedented needs for converted forest products. While the energy needs of developing countries have created ever-increasing demands for fuelwood, global fiber production systems have demonstrated the capability to meet these demands in the aggregate. Regardless, there are some serious local/regional fiber shortages and resource management conflicts.

People worldwide have become increasingly concerned about the future of forests, their health, wildlife diversity, productivity for wood, environmental roles, and aesthetics. As a result of these concerns, the practices of forestry are changing, resulting in iodized wood fiber supply shortages. In addition, many developing countries around the world do not have adequate forest reserves to cover their needs for fuelwood, industrial wood, sawn wood, wood-based building components, etc. However, many of these countries do have relatively large quantities of other materials available in the form of agricultural residues from annual crops. There is therefore an increasing interest in using agricultural fibers for building components, either to complement or replace wood.

Conventional methods of handling agricultural waste, such as waste hay and other plant stalks, include using the same as animal bedding material or compost. Alternatively, the waste is tilled back into the ground with little or no benefit to the soil. The invention presented herein presents an environmentally friendly, economically viable permanent solution for disposing of agricultural waste that further provides a new, renewable source of building components.

Accordingly, it is a primary objective of the present invention to provide a novel method and means of processing and recycling agricultural waste materials.

It is a further objective of the present invention to provide an economical method and means of processing and recycling agricultural waste materials.

It is still a further objective of the present invention to provide a novel method and means of processing and recycling agricultural waste materials resulting in a building product, namely medium density fibreboard.

It is yet a further objective of the present invention to provide a novel method and means of producing fibreboard that does not require the use of expensive resin.

It is a further objective of the present invention to provide a novel method and means of producing fibreboard that is relatively non-toxic.

It is still a further objective of the present invention to provide a novel method and means of producing fibreboard without the use of wood materials.

The method and means of accomplishing each of the above objectives as well as others will become apparent from the detailed description of the invention which follows hereafter.

### SUMMARY OF THE INVENTION

The present invention describes the first fibreboard incorporating non-wood plant straw and a urea formaldehyde (UF) resin or other types of resins, such as PF, melamine, and soy resins, without the need for expensive MDI resin. The fibreboard is produced by removing the pith of plant stalks, cutting the stalks to the desired length, and drying them to a moisture content of 4% or less by weight. The plant stalks are then coated with urea formaldehyde or resins and a wax emulsion. The coated stalks are next formed into a mat and then placed under sufficient heat and pressure to set the resin.

The fibreboard of the present invention provides an economical means of recycling agricultural waste material. Further, as already noted, the fibreboard of the invention is environmentally friendly in that it uses inexpensive, non-wood sources. In addition, the fibreboard is less toxic and expensive than previous fibreboards that require the use of MDI resin.

### DETAILED DESCRIPTION OF THE PREFERRED EMBODIMENT

The present invention relates to the development of an economical, efficient, and non-toxic method of producing a medium-density fibreboard (MDF or MDFB) from non-wood, plant waste materials.

Conventionally, MDF is a composite wood product formed by breaking wood down into fibers, combining the fibers with wax and resin, and forming panels by applying high temperature and pressure. It is a building material similar in application to plywood, but made of sawdust. In contrast to particleboard, MDF has more uniform density throughout the board and has smooth, tight edges that can be machined. It can be finished to a smooth surface and grain printed, eliminating the need for veneers and laminates.

MDF is useful for many applications, from cabinetry to moulding, because it is smooth, uniform, and does not warp. Builders use MDF for such applications as furniture, shelving, laminate flooring, decorative moulding, and doors. MDF is valued for its insular qualities in sound and heat. Also, it can be nailed, glued, screwed, stapled, or attached with dowels, making it as versatile as plank wood.

The general steps used to produce conventional MDF include mechanical pulping of wood chips to fibers (refining), drying, blending fibers with resin and usually a wax, forming the resinated material into a mat, and hot pressing. The means of making the MDF of the present invention differs from this conventional method by using agricultural fibers and atmospheric refining technologies prior to forming and pressing.

The fibreboard of the present invention can be made of any plant stalks that do not have a waxy outer cuticle, such as soybean and cotton, bagasse stalks, rice, bamboo, etc. The first step in manufacturing the fibreboard is to remove the pith from the plant stem or stalk. Removal of the pith prior to treatment is necessary since otherwise the pith will absorb most of the resin used in forming the fibreboard. Various means are known in the art for depithing plant stalks, including the apparatuses described in U.S. Pat. Nos. 4,202,078 and 4,231,529, as well as use of knives, blades, pressure rollers, etc. The pith may also be removed using the machine described in the inventors' co-pending applications describing a depithing machine, Ser. Nos. 11/213,206 and PCT/US06/029357, the disclosures of which are hereby expressly incorporated by reference. The depithing process will preferably longitudinally split the plant stem to enable coating of all surfaces of the plant fiber with the resin in the later step.

The depithed stalks are next cut to the desired length for application in fibreboard, which will generally range from about 2-3 inches. The fibers are then preferably screened using conventional methods to remove any remaining pith, fines and powder which tend to absorb too much of the resin. The materials screened from the fibers may be used as fuel in the heating and drying steps described below.

In a preferred embodiment of the invention, the fibers are steamed or otherwise moisturized in order which causes the fibers to open. A preferred means of moisturizing the fibers is to place them in a steam chest whereby the fibers are exposed to pre-heated steam with a high degree of moisture content. The fibers are preferably steamed to a moisture content of up to about 20% by weight.

The fibers are next broken down further into fiber-like threads that are suitable for forming into mats. A preferred means of doing so is through the use of an atmospheric disk refiner, also known as an attrition mill, which makes the fibers into bundles. Such refiners use single or double counter revolving disks to mechanically break down the fibers into threads suitable for manufacturing into a fibreboard, and do not require the input of pressure or heat, unlike the pressurized refiners used in conventional MDF manufacturing processes. As a general guideline, the fibers may be refined to a diameter as small as a human hair.

The fibers are then dried to a moisture content of about 4% or less. While it is possible to have higher moisture content and achieve a workable final product, moisture content of greater than about 4% is not preferred since moisture content above this level will result in a weaker final product and/or delamination, blows, etc. Tube dryers are typically used to reduce the moisture content of the fibers to the desired levels. Heat is usually provided by the direct firing of propane, natural gas, distillate oil, or fines screened from the fibers as already described above. Conventional MDF dryers, such as blowpipes in blowline systems, may be used, having inlet temperatures generally ranging between about 1000-1200° F. (about 535° -650° C.), with about 1100° F. (593° C.) being preferred.

The fibers are typically dried for a time period of about 1-2 minutes, or at a temperature and for a time period sufficient to reduce the moisture content of the materials to the desired level, and preferably to a moisture content of about 4% or less by weight. The drying time and/or temperature may be adjusted according to the temperature and the moisture content of the input materials.

The sequence of the drying and blending operations depends on the method by which the resins and other additives are blended with the fibers. Some MDF plants inject resins into a short-retention blender, while others inject resin formulations into a blowline system. If resin is added in a separate blender, the fibers are first dried and separated from the gas stream by a primary cyclone, then conveyed to the blender. A blowline system is preferred for use in the present invention.

In the blowline system, at least a resin and preferably also a wax emulsion are applied to the fibers while the fibers are leaving the dryer, as well as any other desired additives. Application of a wax is preferred to improve the flowability of the resin, as well as providing additional moisture resistance. As already noted, the materials may also be applied by other conventional means known in the art, such as a short-retention blender, whereby the resin and wax are applied preferably by means of spray nozzles, tubes, or atomizers.

The present invention preferably incorporates a urea formaldehyde (UF) resin. UF is a relatively inexpensive, transparent, thermosetting resin made from urea and formaldehyde heated in the presence of a mild base, such as ammonia or pyridine. UF has a high tensile strength, flexural modulus and HDT, low water absorption and mould shrinkage and higher surface hardness, elongation at break, and volume resistance. UF is preferred for use in the invention simply for economical reasons. It is also preferred to incorporate melamine urea formaldehyde (MUF) resin along with or instead of the UF resin in order to impart additional water resistance to the fibers.

Instead or in addition to UF, the present invention may also incorporate other resins known in the art for use in MDF, such as a phenol formaldehyde (PF) resin. PF resin is a relatively inexpensive, red/black-colored resin that is used in pressed wood products such as softwood plywood and flake or oriented fibreboard for exterior applications. MDI resin may also be used, although its use is not preferred due since it is significantly more expensive than formaldehyde resins.

The present invention also contemplates that various other resins may added to the primary resin used, such as soy-based or canola-based resins, and other melamines. Resins that combine a majority of soy protein and a formaldehyde are known in the art. Some that include UF or PF have recently been produced by Heartland Resource Technologies (HRT), and are suitable for use in this invention. As already noted, preferred fibreboards of the invention are substantially free of MDI resin for reasons of safety and economy. As used herein, “substantially free of MDI resin” means the resin does not include detectable amounts of MDI resin.

The UF or other resin(s) are applied to the fibers in a concentration of at least 5% by weight of the fiber, with about 5-10% by weight being preferred. More than 10% by weight resin can be included, but any more than about 12% by weight will not provide additional benefit to the final product, and may result in too much moisture in the product.

As noted, waxes are preferably added to impart water resistance and to assist in dispersing the resin on all surfaces of the fibers. A wax emulsion is also preferably applied to the fibers along with the resin in a concentration of at least 0.5% by weight of the fiber. Wax emulsions are well known in the art and include, but are not limited to, synthetic amide, carnauba, carnauba/micro, carnauba/paraffin, carnauba/PE, EAA, microcrystalline, paraffin, paraffin/EAA, paraffin/micro, paraffin/PE, polyethylene, polypropylene, scale, beeswax, lanolin, lanocerin, shellac, ozokerite, candelila, jojoba, ouricouri, montan, intermediate, etc. Various manufacturers of wax emulsions are Michem®, Paracol®, and Microlube®. A preferred concentration of wax emulsion is between about 0.5-2% by weight. Once the concentration of emulsion exceeds 2%, the materials tend to become too wet, and therefore amounts greater than 2% by weight are not preferred. The resin and the wax can be applied separately, although it is preferred to add them simultaneously for uniformity.

Other miscellaneous ingredients may be included in the fibreboard depending upon the product specification. Such ingredients may include, but are not limited to coloring agents, lubricants, borax or other fire retardants, etc. If included, these minor ingredients generally will not constitute more than 2% by weight of the fibreboard. Again, these ingredients can be applied to the fiber separately from the resin and/or the wax, but it is preferred to apply the ingredients together for purposes of uniformity.

Blenders are generally used to discharge the resinated fibers into a plenum over a belt conveyor that feeds the blended material to a forming machine, which deposits the resinated material in the form of a continuous mat. Formers use air or mechanical means to convey the material to the forming conveyor. To produce multilayer fibreboard, several forming heads can be used in a series. As it leaves the former, the mat may be prepressed to a depth of about 10-12 inches prior to pressing.

The press applies heat and pressure to activate the resin and bond the fibers into a solid board. Although some single-opening presses are used, most fibreboard plants are equipped with multi-opening batch presses. The press time generally ranges between about 3-9 minutes. Continuous presses may also be used to produce the fibreboard. Presses generally are heated using steam. However, hot oil and hot water may also be used to heat the press. The operating temperature for the presses generally range from about 300-360° F. (149-182° C.), with about 320-340° F. being preferred. Typically, the pressure will range from about 3000-3500 psi, with about 3200 psi being preferred. The press temperature, pressure, and time will vary according to the product being produced. The final product is pressed to a depth that will generally range from about ⅜ to 1.25 inches. The product will be of varying densities depending on the specifications of the buyer.

After pressing, the boards are generally cooled prior to stacking. The fibreboards are then sanded and/or trimmed to the final desired dimensions, any other finishing operations (such as laminate or veneer application) are done, and the finished product is packaged for shipment.

The following examples are offered to illustrate but not limit the invention. Thus, they are presented with the understanding that various formulation modifications as well as method of delivery modifications may be made and still be within the spirit of the invention.

### EXAMPLE 1

### Manufacture of Soy-Based Medium Density Fibreboard

Two groups of soy MDF (designated as groups “A” and “B”) in accordance with the present invention were synthesized. The data summary is set forth in Table 1:

TABLE 1

| | | | | | Mean | | | | | | |
|---|---|---|---|---|---|---|---|---|---|---|---|
| Group | | Resin | Resin | EW58S | Density | Mean | IB Std | IB/ | | MOR | Emissions |
| ID | Material | System | Solids | Solids | (pcf) | IB (psi) | Dev | Density | MOE (psi) | (psi) | (ug/mL) |
| A | Soy | WF11/ | 12%/ | 0.5% | 50.51 | 79.27 | 11.38 | 1.57 | 345,436 | 2,976 | 0.124 |
| | | Scav500¹ | 0.3% | | | | | | | | |
| B | Soy | PL2C1¹ | 12.0% | 0.5% | 50.88 | 111.04 | 15.37 | 2.18 | not | not | 0.267 |
| | | | | | | | | | tested | tested | |

A = Soy Fiber 18 × 18
B = Soy 22 × 22
¹WF11/Scav500 and PL2C are brands of UF resin manufactured by Hexion Specialty Chemicals.

The trial plan for synthesis of the MDFs is set forth in Table 2:

TABLE 2
Resin Information

| | |
|---|---|
| Core | WF11 SCAV500, PL2C |
| Surface (LPF) | WF11 SCAV500, PL2C |
| E-Wax | EW58S |

Other Information

| Panel Thickness | ½″ (12.7 mm after sanding) | | | | | | |
|---|---|---|---|---|---|---|---|
| | (15.2 mm before sanding - out of press) | | | | | | |
| Press Temperature | 400 F. | | | | | | |
| Wood Furnish | Soy straw | | | | | | |
| Surface/Core Ratio | 100 | | | | | | |
| Target Panel Density | 49 pcf | | | | | | |
| | | | Press Cycle | | | | |
| | | | Closing | Hold | Venting | Total | |
| Number | Group | Density | Time | Time | Time | Cycle | Furnish |
| of Panels | I/D | (lb/ft3) | (sec) | (sec) | (sec) | Time | MC (%) |
| OSB-R1 | | | | | | | |
| 5 | A | 49 | 60 | 210 | 60 | 330 | 4.0% |
| 7 | B | 49 | 60 | 210 | 60 | 330 | 4.0% |

| | | | Surface Add-On Rates | | | |
|---|---|---|---|---|---|---|
| | | | | Resin | E-Wax | |
| Number | Group | Density | Resin | Solids | (% | Furnish |
| of Panels | I/D | (lb/ft3) | System | (%) | solids) | MC (%) |
| OSB-R1 | | | | | | |
| 5 | A | 49 | WF11/ | 12%/0.3% | 0.5% | 4.0% |
| | | | Scav500 | | | |
| 7 | B | 49 | PL2C | 12.0% | 0.5% | 4.0% |

| | | | Core Add-On Rates | | |
|---|---|---|---|---|---|
| | | | | | E-Wax |
| Number | Group | Density | Resin | Resin | (% |
| of Panels | I/D | (lb/ft3) | System | Solids (%) | solids) |
| OSB-R1 | | | | | |
| 5 | A | 49 | WF11/ | 12%/0.3% | 0.5% |
| | | | Scav 500 | | |
| 7 | B | 49 | PL2C | 12.0% | 0.5% |

A = Soy Fiber 18 × 18
B = Soy 22 × 22

Table 3 below sets forth the physical characteristics of the Group A and B samples:

TABLE 3

| Sample ID | Weight (g) | Thickness (″) | Sample Density | Sample IB (psi) |
|---|---|---|---|---|
| A4-1 | 25.1 | 0.502 | 47.33 | 54.51 |
| A4-2 | 26.8 | 0.508 | 49.94 | 66.38 |
| A4-3 | 27.1 | 0.506 | 50.70 | 81.57 |
| A4-4 | 27.6 | 0.509 | 51.33 | 85.25 |
| A4-5 | 27.9 | 0.505 | 52.30 | 86.77 |
| A5-1 | 27.4 | 0.502 | 51.67 | 78.22 |
| A5-2 | 26.6 | 0.500 | 50.36 | 88.88 |
| A5-3 | 27.2 | 0.499 | 51.60 | 92.24 |
| A5-4 | 27.2 | 0.500 | 51.50 | 74.04 |
| A5-5 | 26.6 | 0.501 | 50.26 | 76.90 |
| A6-1 | 27.8 | 0.507 | 51.90 | 80.19 |
| A6-2 | 28.2 | 0.507 | 52.65 | 92.05 |
| A6-3 | 27.1 | 0.503 | 51.00 | 78.09 |
| A6-4 | 26.7 | 0.507 | 49.85 | 65.27 |
| A6-5 | 27.3 | 0.508 | 50.87 | 85.09 |
| A7-1 | 24.8 | 0.512 | 45.85 | 60.39 |
| A7-2 | 26.8 | 0.510 | 49.74 | 73.83 |
| A7-3 | 27.4 | 0.511 | 50.76 | 79.21 |
| A7-4 | 27.3 | 0.510 | 50.67 | 74.84 |
| A7-5 | 27.0 | 0.509 | 50.21 | 77.56 |
| A8-1 | 25.2 | 0.506 | 47.14 | 61.75 |
| A8-2 | 27.0 | 0.499 | 51.22 | 98.46 |
| A8-3 | 26.9 | 0.504 | 50.52 | 71.73 |
| A8-4 | 26.9 | 0.499 | 51.03 | 95.28 |
| A8-5 | 27.7 | 0.502 | 52.23 | 102.46 |
| Group | | inch | lbs/ft³ | psi |
| Averages | | | | |
| Imperial | | 0.505 | 50.51 | 79 |
| Group | | mm | kg/m³ | N/mm^{2 (MPa)} |
| Averages | | | | |
| Metric | | 12.83 | 809 | 0.547 |
| B1-1 | 27.5 | 0.497 | 52.38 | 111.12 |
| B1-2 | 26.7 | 0.496 | 50.96 | 85.46 |
| B1-3 | 26.9 | 0.499 | 51.03 | 88.27 |
| B1-4 | 27.1 | 0.502 | 51.10 | 92.84 |
| B1-5 | 26.9 | 0.495 | 51.44 | 111.76 |
| B2-1 | 28.0 | 0.525 | 50.49 | 118.96 |
| B2-2 | 28.4 | 0.529 | 50.82 | 114.14 |
| B2-3 | 28.0 | 0.533 | 49.73 | 127.74 |
| B2-4 | 27.8 | 0.520 | 50.61 | 121.55 |
| B2-5 | 27.8 | 0.526 | 50.03 | 121.99 |
| B2-6 | 28.4 | 0.526 | 51.11 | 127.62 |
| Group | | inch | lbs/ft3 | psi |
| Averages | | | | |
| Imperial | | 0.513 | 50.9 | 111 |
| Group | | mm | kg/m3 | N/mm2 (MPa) |
| Averages | | | | |
| Metric | | 13.04 | 815 | 0.766 |

Persons skilled in the art will readily understand that the processes described above may be performed in a one-step process, or in several steps. In the alternative, the process of this invention may take place in several steps and in numerous chambers or containers in a factory or manufacturing process. Persons skilled in the art will also readily appreciate that the processes of this invention may be accomplished using a variety of equipment and techniques that are well known in the art. The specific equipment used is not critical to the process.

It should be appreciated that minor modifications of the composition and the ranges expressed herein may be made and still come within the scope and spirit of the present invention.

Having described the invention with reference to particular compositions, theories of effectiveness, and the like, it will be apparent to those of skill in the art that it is not intended that the invention, be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

What is claimed is:

1-8. (canceled)

9. A method of manufacturing medium density fibreboard from agricultural waste comprising:
depithing soybean plant stalks;
moisturizing the soybean stalks;
breaking down the moisturized soybean stalks into fiber-like threads;
reducing the moisture content of the threads to form dried material;
applying a formaldehyde resin to the dried material; and
curing the resin to form a fibreboard.

10. The method of claim 9 whereby the soybean plant stalks are split longitudinally during the depithing act.

11. The method of claim 9 further comprising the step of applying a wax to the dried material.

12. (canceled)

13. The method of claim 9 further comprising the acts of:
cutting the depithed soybean stalks to a desired length; and
screening the cut soybean stalks to remove remaining pith, fines, or powder.

14. The method of claim 9 whereby the threads are dried to a moisture content of about 4% by weight or less.

15. (canceled)

16. The method of claim 9 wherein the act of moisturizing the soybean stalks comprises steaming the soybean stalks prior to the breaking down, such that the concentration of the water in the soybean stalks during the breaking down act is increased to 20% by weight.

17-22. (canceled)

23. A method of forming fibreboard, comprising:
cutting soybean stalks to a desired length;
removing pith, fines and powder from the cut soybean stalks;
moisturizing the cut soybean stalks;
breaking down the moisturized soybean stalks into refined soybean fiber threads;
drying the refined soybean fiber threads to a moisture content of about 4% or less;
applying a resin to the dried soybean fiber threads to form a resinated soybean thread material, a majority of the resin comprising a formaldehyde resin;
forming a mat from the resinated soybean thread material; and
pressing the mat into a solid board.

24. The method of claim 23, wherein the act of moisturizing the cut soybean stalks comprises steaming the cut soybean stalks to a moisture content of about 20% by weight.

25. The method of claim 23, wherein the act of removing remaining pith, fines and powder from the cut soybean stalks is performed by screening.

26. The method of claim 23, wherein the refined soybean fiber threads are dried and separated from a gas stream in a primary cyclone.

27. The method of claim 23, wherein the formaldehyde resin is a urea formaldehyde resin.

28. The method of claim 23, wherein the resin comprises less than 10% MDI resin by weight of the resin.

29. The method of claim 28, wherein the resin is substantially free of MDI isocyanate.

30. The method of claim 23, wherein the resin is applied to the dried soybean fiber threads in an amount of about 5-12% by weight of the dried soybean fiber threads.

31. The method of claim 23, wherein the act of removing pith comprises splitting the soybean stalks longitudinally.

32. The method of claim 23, further comprising:
using the removed fines and powder as fuel in the drying act.

33. The method of claim 23, further comprising:
applying a wax emulsion to the dried soybean fiber threads, wherein the wax emulsion is applied to the dried soybean fiber threads in an amount of at least 0.5% and no greater than 2% by weight of the dried soybean fiber threads.

34. The method of claim 33, wherein the resin and wax emulsion is applied to the dried soybean fiber threads using spray nozzles, tubes or atomizers.

35. The method of claim 23, further comprising adding other ingredients in the fibreboard in an amount greater than 0 to no more than 2% of the weight of the fibreboard, such other ingredients selected from the group consisting of:
coloring agents;
lubricants; and
borax or other fire retardants.

36. The method of claim 23, wherein the mat is pressed in a press at an operating temperature of 300-360° F. at a pressure of about 3000-3500 psi.

37. The method of claim 23, wherein the mat has a depth of 10-12 inches prior to pressing, and wherein the board had a thickness of ⅜ to 1.25 inches.

38. The method of claim 23, wherein the board has a density in the range of 45.85-52.65 pcf.

39. The method of claim 23, wherein the refined soybean fiber threads are refined to a diameter as small as a human hair.

40. A method of forming fibreboard, comprising:
breaking down soybean stalks into refined, depithed soybean fiber threads, the threads being refined to a diameter as small as a human hair;
drying the refined, depithed soybean fiber threads to a moisture content of about 4% or less;
applying a resin to the dried soybean fiber threads to form a resinated soybean thread material, a majority of the resin comprising a formaldehyde resin;
forming a mat from the resinated soybean thread material; and
pressing the mat into a solid board.
